(19) United States
(12) Patent Application Publication
(10) Pub. No.: US 2023/0235879 A1
(43) Pub. Date: Jul. 27, 2023

(54) SYSTEM FOR BATTERY TESTING WITH AN IGNITION DEVICE FOR EXHAUST GASSES

(71) Applicant: SAMSUNG SDI CO., LTD., Yongin-si (KR)

(72) Inventors: Wolfgang REINPRECHT, Attendorf (AT); Stefan REINPRECHT, Attendorf (AT)

(21) Appl. No.: 18/152,604

(22) Filed: Jan. 10, 2023

(30) Foreign Application Priority Data
Jan. 10, 2022 (EP) 22150756.9
Jan. 10, 2023 (KR) 10-2023-0003426

(51) Int. Cl. F23G 7/06; F23J 15/02

(52) U.S. Cl. CPC F23G 7/06; F23J 15/027; F23G 2209/14; F23J 2217/10

(57) ABSTRACT

A battery testing system includes: a test chamber; a battery test platform within the test chamber, the battery test platform being configured to accommodate a battery and to performing a test to the battery; and an ignition device configured to combust exhaust gases produced in the test chamber during the battery test while the exhaust gasses are in the battery testing system.

### CROSS-REFERENCE TO RELATED APPLICATION

This application claims priority to and the benefit of European Patent Application No. 22150756.9, filed in the European Patent Office on Jan. 10, 2022, and Korean Patent Application No. 10-2023-0003426, filed in the Korean Intellectual Property Office on Jan. 10, 2023, the entire content of both of which are incorporated herein by reference.

### BACKGROUND

### 1. Field

Aspects of embodiments of the present disclosure relate to a system for battery testing with an ignition device for exhaust gases.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery’s intended purpose. Lithium-ion (and similar lithium polymer) batteries, widely known via their use in laptops and consumer electronics, dominate the most recent electric vehicles in development.

Exothermic decomposition of cell components may lead to a so-called thermal runaway. Generally, thermal runaway describes a process that is accelerated by increased temperature, in turn releasing energy that further increases temperature. Thermal runaway occurs when an increase in temperature changes the conditions inside a cell that causes a further increase in temperature, often leading to a destructive result. In rechargeable battery systems, thermal runaway is associated with strong exothermic reactions that are accelerated by temperature rise. Such exothermic reactions include the combustion of flammable gas compositions within the battery pack housing. For example, when a cell is heated above a critical temperature (typically above about 150° C.), it can transit (or transition) into a thermal runaway. The initial heating may be caused by a local failure, such as a cell internal short circuit, heating from a defective electrical contact, a short circuit to a neighboring cell, etc. During the thermal runaway, a failed battery cell (e.g., a battery cell that has a local failure) may reach a temperature exceeding about 700° C. Further, large quantities of hot gas are ejected from inside the failed battery cell through the venting opening of the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack.

To mitigate the risk for thermal runaway and/or to assure a desired robustness of the battery (e.g., battery cell, battery housing, and/or battery pack), batteries undergo tests in which they are exposed to potentially damaging conditions, such as high or low temperatures, mechanical forces, mechanical damage, and the like.

### SUMMARY

The present disclosure is defined by the appended claims and their equivalents. Any disclosure lying outside of said scope is intended for illustrative as well as comparative purposes.

During battery testing, batteries may release contaminated gases due to, for example, overpressure buildup during a thermal runaway process. One objective of the battery testing system is to prevent or mitigate the release of such contaminated exhaust gases to an environment outside the battery system. Air filters are often used to capture contaminants in the exhaust gasses prior to releasing them outside the battery system. However, certain flammable gasses are more difficult to filter and may be released from the testing systems.

According to one embodiment of the present disclosure, a battery testing system includes: a test chamber, a battery test platform within the battery test chamber and configured to accommodate a battery and to facilitate performing a test to the battery; and an ignition device configured to combust (e.g., to affect combustion of) exhaust gases produced in the test chamber during the battery test while the exhaust gasses are in the testing system.

Another embodiment of the present disclosure provides an exhaust gas treatment device operable in a test chamber for battery testing. The gas treatment device includes an ignition device configured to combust exhaust gases produced in the test chamber during a battery test while the exhaust gasses are in the test chamber.

Yet another embodiment of the present disclosure provides a method for exhaust gas treatment in a battery testing system. The method includes: performing a battery test procedure on a battery, igniting exhaust gases produced during the battery test procedure to combust the exhaust gases; guiding the combusted gases through a filter; and filtering pollutants from the guided combusted gases.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 illustrates a schematic view of a gas treatment device including an ignition device and a cyclone filter according to an embodiment.

FIG. 2 illustrates a schematic view of a gas treatment device including an ignition device, a cyclone filter, and a fine particle filter according to an embodiment.

FIG. 3 illustrates a schematic view of a gas treatment device including an ignition device, a cyclone filter, and a combustion barrier according to an embodiment.

FIG. 4 illustrates a schematic view of a gas treatment device including an ignition device, a cyclone filter, a fine particle filter, and a combustion barrier according to an embodiment.

FIG. 5 illustrates a schematic view of a battery test setting with a gas treatment device placed on a test platform according to an embodiment.

FIG. 6 illustrates a schematic view of a battery test setting with a gas treatment device placed on a test platform according to an embodiment.

FIG. 7 illustrates a schematic functional view of a hood structure according to an embodiment.

FIG. 8 illustrates a schematic cross-sectional view of a hood structure according to an embodiment.

FIG. 9 illustrates a schematic view of a hood structure with a safety flap during normal operation of a vent according to an embodiment.

FIG. 10 illustrates a schematic view of a hood structure with a safety flap during faulty operation of a vent according to an embodiment.

FIG. 11 illustrates a schematic view of a battery testing system according to an embodiment.

FIG. 12 illustrates a schematic view of a battery testing facility according to an embodiment.

### DETAILED DESCRIPTION

Reference will now be made in detail to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided so that this disclosure will be thorough and complete, and will fully convey the aspects and features of the present disclosure to those skilled in the art.

Accordingly, processes, elements, and techniques that are not considered necessary for those of ordinary skill in the art to have a complete understanding of the aspects and features of the present disclosure may be omitted or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Herein, the terms “upper” and “lower” are defined according to the z-axis. For example, the upper cover is positioned at the upper part of the z-axis, and the lower cover is positioned at the lower part thereof. However, spatially relative terms, such as “beneath,” “below,” “lower,” “above,” “upper,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

During battery testing, flammable gases, such as gasses including H₂, CO, and/or CₓHₓ particles, may be exhausted from the battery being tested. Because common filters may not effectively absorb/filter these gases, these gases may be introduced to the environment and result in polluted, and potentially dangerous, air.

According to one embodiment of the present disclosure, an exhaust gas treatment device (e.g., the gas treatment device) is provided. The gas treatment device is operable in (e.g., is arranged in) a test chamber for battery testing for treating exhaust gasses in the test chamber. The gas treatment device includes at least one ignition device configured to affect the combustion of (e.g., configured to ignite or combust) exhaust gases produced in the test chamber during a battery test while the exhaust gasses are in the test chamber.

In some embodiments, a battery testing system includes a test chamber, a battery test platform, and at least one ignition device. For example, the battery test platform may be positioned within the battery test chamber and configured to accommodate a battery being test (e.g., a battery under test) and to facilitate performing a battery test, and the at least one ignition device is configured to affect the combustion of exhaust gases produced in the test chamber during the battery test while the exhaust gasses are in the testing system.

Affecting combustion of exhaust gases burns (e.g., ignites) the flammable gases, which results in safe particles, such as H₂O and CO₂, and larger ash particles that can be filtered from the burned exhaust gasses before the gasses are released to the environment.

In other words, the exhaust gases, which can include flammable gases, are ignited by the ignition device before being released into the environment. The burned exhaust gasses may be less harmful to the environment, especially when the debris of the burned materials is filtered.

The battery, as referenced herein, is a device under test, or a battery under test, where test procedures are performed with the battery to assure a robustness thereof and/or compliance with certain standards, such as battery performance tests under ISO 12405-1 or GB 18384-2020. One test that can be performed on the battery is a thermal propagation test.

According to embodiments of the present disclosure, lower emissions related to battery testing may be achieved while maintaining safe testing procedures.

To facilitate performing a test on a battery, a test platform is used to accommodate the battery under test. In some embodiments, the test platform includes sensors, such as temperature sensors, VOC sensors, or the like. In some embodiments, the test platform includes test equipment or facilitates access to test equipment to affect (e.g., to cause) certain conditions on the battery under test.

The conditions affected during testing include one or more of mechanical forces, air pressure, temperature, exposure to certain materials, and the like.

The test equipment may include cooling or preheating stimuli for the battery under test as well as electric or mechanical force and loads with the relevant sensors during the thermal runaway event.

A mechanical condition, which forms a part of a mechanical induced thermal runway test, includes a mechanical impact, which produces the conditions for a crush test.

The testing of a battery may result in exhausting contaminated gasses, excessive heat, fire, and even explosion. As the energy density of batteries increases, the risk for combustion, explosion, and excessive heat during testing may increase.

Therefore, tests for batteries are generally performed in a controlled environment, such as a test chamber, where the risks associated with the test procedures can be mitigated. The test chamber is designed to reduce the risk of intruding contaminants, such as contaminated gasses, hazardous metals, or other chemicals, related to the test procedure to the environment.

One of the potentially contaminating factors in a test procedure is burnable (e.g., flammable) gasses, which, according to embodiments of the present disclosure, are burned with an ignition device to reduce the risk of their release to the environment.

According to some embodiments, the ignition device is configured to affect the combustion of burnable gasses by inducing high-temperature conditions to the burnable gasses. In some embodiments, the ignition device induces high-temperature conditions by providing plasma, such as a spark. The ignition device can be electrically operated. One example of an ignition device is a glow-pin or a spark device, which generates a spark by delivering electric/ionic current between two separated electrodes, such that the spark is generated in the space between the electrodes.

According to some embodiments, the ignition device operates continuously, for example, by providing a continuous current and creating a continuous spark. In other embodiments, the ignition device is operated intermittently, for example, in pulses, where sparks are generated recurrently at a fixed or controllable (e.g., variable) rate/frequency, thereby determining an ignition frequency.

According to some embodiments, the ignition rate, corresponding to the frequency of ignition, is in a range of about 0.1 sparks per second to about 100 sparks per second. In some embodiments, the ignition rate is in a range of about 1 spark per second to about 10 sparks per second.

In some embodiments, the intensity of the ignition is controllable. For example, the spark intensity is controllably reduced or increased.

According to some embodiments, the ignition device is operable in one or more of the following operation modes: (1) no ignition, where the ignition device does not induce combustion; (2) low-mode, where the ignition device operates at a rate and/or intensity below a threshold; and (3) high-mode, where the ignition device operates at a rate and/or intensity above the threshold.

According to some embodiments, the operation mode of the ignition device, the intensity, and/or the frequency of ignition are controllably determined based on a determined (or monitored or measured) condition in the test chamber. Such conditions may include a phase/step in the testing procedure, temperature measurement in the test chamber, detection of burnable gases in the test chamber, and the like.

According to some embodiments, the ignition device includes a spark plug device, which produces an electric high voltage spark by applying sufficient energy to ignite the mixture of exhaust gasses. In other embodiments, a high-temperature ignition element, such as a high temperature metallic or ceramic element, are included in the ignition device, that affects ignition by the presence of heat. In one embodiment, the ignition device includes an arcing device, such as a spark device, as the arc affects significantly increased temperatures, which would result in an effective ignition.

In some embodiments, the exhaust gas treatment device or system may also include at least one filter configured to remove contaminants from gasses passing therethrough and a vent configured to direct the exhaust gasses through the filter, affecting a directed air stream in which a downstream direction is a direction in which air is guided through the filter. The at least one filter is placed downstream of the at least one ignition device such that the at least one ignition device is configured to affect the combustion of exhaust gases prior to the exhaust gases being directed through the at least one filter.

According to another embodiment of the present disclosure, a method for exhaust gas treatment in a battery testing system is provided. The method includes performing a battery test procedure on a battery under test, igniting exhaust gases produced during the battery test procedure to affect combustion thereof, guiding the combusted gases through a filter, and filtering pollutants/contaminants from the guided combusted gases.

The vent creates a directed gas flow in which the exhaust gases released from the battery are directed to the vicinity of the ignition device to be combusted, and thereafter, the directed gas flow directs the burned exhaust gasses through a filter for removing contaminating particles from the burned exhaust gasses.

As used herein, the term “vent” may describe an apparatus configured to affect a movement of air in a certain direction or flow. A vent may include a fan and/or may be any revolving vane or vanes used for producing currents of air, such as blades, axially rotatable to affect the movement of air to create a flow of air or air currents. A vent may also be any one of an axial-flow vent, a centrifugal vent, a cross-flow vent, or the like.

According to some embodiments, a flow rate of the vent is in a range of about 100 m³/h to 10000 about m³/h. In some embodiments, the flow rate of the vent is greater than about 1000 m³/h. In some embodiments, the flow rate of the vent is about 1800 m³/h. In some embodiments, the flow rate of the vent is about 3600 m³/h or greater than about 3000 m³/h.

A pass-through volume based on the maximum size of the battery system, or battery under test, is provided to provide gases with temperatures below a certain threshold, according to abilities (e.g., the flow rate and/or filtering abilities of) the filtering system. In one embodiment, the vent type is a centrifugal system, which provides tolerance to different loads of the exhaust gas flow. Axial vents (ATEX) may be used in areas where the exhaust gases are not yet ignited as well as to support emergency cases.

According to some embodiments, the vent is operated to affect a gas flow in a certain direction or path. According to some embodiments, the device or system further includes gas flow guidance elements, such as plates, flaps, conduits, inlets, and the like, in which the gas flow is directed or confined in a path in combination with the operation of the fan.

As used herein, the adjacency relation between two components is determined such that gas is directed, under the operation of the vent, from one component to the other. For example, the operation of the vent affects (or causes) an under-pressure, which sucks gas through one component and affects an under pressure by an inlet section of the respective component, such that, gas from an adjacent component is pulled into the inlet section.

As used herein, the term “filter” may describe an apparatus configured for removing particles, such as solid particles from air (or gas) passing therethrough. The filter may operate to remove particles by adsorption, absorption, and/or separation, and may be configured to remove particles based on the properties of the filtered particles. Properties of the filtered particles, based on which the filter removes them from the gasses, may include one or more of: size/dimensions of the particles; weight of the particles; density of the particles; chemical properties of the particles, such as reactivity to certain materials; and/or electrical properties of the particles.

According to some embodiments, the filter includes a porous or fibrous medium that removes solid particles from the air by absorption or adsorption. Such filters may be made of one or more of paper, foam, cotton, cloth, stainless steel, or the like.

According to some embodiments, the filter is a centrifugal filter, such as a cyclone filter, configured to separate particles from gasses passing therethrough according to (e.g., by using) differential mechanical forces resulting, for example, from affecting a vortex to the air. According to some embodiments, the filter can include one or more of a settling chamber, baffle chamber, a single-cyclone separator, or a multiple-cyclone separator.

According to some embodiments, the filter can be a large-particle filter (also referred to as a coarse filter), or a fine-particle filter, such as a fine filter, a semi HEPA filter, a HEPA filter, or a ULPA filter.

According to some embodiments, a large-particle filter is configured to filter particles larger than about 10 µm.

According to some embodiments, a fine-particle filter is configured to filter particles larger than about 1 µm.

According to some embodiments, within the test chamber where the venting gas is ignited, large particles from (e.g., exhausted from) the device under test are mixed with the exhaust gasses, and these will be primarily filtered by the cyclone filter system, which is configured to filter most of the large particle passing therethrough. The cyclone filter is relatively easy to service. The fine dust filter, generally, requires more frequent service and some require replacement after a small amount of dust is accumulated therein, for example, about 400 g of dust or particles. Therefore, according to some embodiments, the fine dust filter receives exhaust gases with a contaminant particle size of less than about 10 µm because larger contaminants particles are filtered by the cyclone filter.

Further cyclone filters may be made of steel, which can withstand much higher temperatures, including up to about 1000° C., such that combustion flames can reach into it without damaging or destroying it.

According to an embodiment, the at least one large-particle filter is placed adjacent to and downstream of the at least one ignition device. In one embodiment, the large-particle filter is a cyclone filter placed adjacent to and downstream of the at least one ignition device.

The cyclone filter, or cyclone separator, is configured for removing particulates from air through vortex separation with or without the use of filtration membranes. When a gas cyclone is used, which rotates the gas, the rotational effects (or forces) and gravity are used to separate large or heavy particles from the gas.

According to some embodiments, the vortex is created by the airflow affected by the operation of one or more of the vents.

The large-particle filter, such as a cyclone filter, is usually operable with high-temperature gasses passing therethrough.

According to some embodiments, the large-particle filter is operable with gas temperatures in the range of about 100° C. to about 1000° C. For example, a large-particle filter may be operable with gas temperatures of approximately 130° C.

According to an embodiment, the system or device may further include a fine-particle filter placed downstream of the large-particle filter, such as the cyclone filter, which is configured to filter contaminants from exhaust gasses that passed through the large-particle filter.

Placing the fine-particle filter downstream of the large-particle filter reduces the average contaminant particles size in the gas introduced to the fine-particle filter, thereby mitigating the risk of clogging and reducing the frequency of maintenance operations, such as cleaning or replacement, of the fine-particle filter.

According to some embodiments, the fine-particle filter and the large-particle filter are placed adjacent to one another and/or are connected through a conduit such that the gas passing through the large-particle filter is directed/forced through the fine-particle filter. In other embodiments, the fine-particle filter and the large-particle filter are spaced apart in the test chamber, thereby allowing for the introduction of clean gases to be mixed with the exhaust gasses prior to being guided through the fine-particle filter.

In other words, according to some embodiments, the large-particle filter is a primary filter through which the gas passes first, and the fine-particle filter is a secondary filter through which gas passes after passing through the primary filter.

According to some embodiments, the device or system further includes at least one of a first gas inlet configured to introduce non-exhaust gases (e.g., fresh air) to the exhaust gases prior to the combustion and/or a second gas inlet between the at least one ignition device and the filter configured to introduce non-exhaust gases to exhaust gases after the combustion thereof and prior to the combusted exhaust gases being directed through the at least one filter.

As used herein, the term “inlet” may describe a structure that allows for the introduction of gas there through from one region to another region on both sides of the inlet. An inlet can be an opening, such as a hole, an aperture, a crack, a slit, an orifice or the like, in a conduit, cavity, container, passage, or the like, facilitating an intake/outtake of gas therethrough.

If the concentration of burnable gases being ignited is high, the combustion might not be effective (or totally effectively) and flammable gases may remain unburned (e.g., uncombusted) and may pass through the device or system. The first gas inlet introduces non-exhaust gases to be mixed with the exhaust gases released from the battery under test, such that a mixed gas is introduced to the ignition device to facilitate efficient combustion of the exhaust gasses.

Combustion can increase the temperature of the exhaust gasses significantly, which might affect the operation or effectiveness of one of more of the filters. The second gas inlet is configured to introduce non-exhaust gases to the burned exhaust gases, thereby reducing the temperature of the exhaust gases being introduced to one or more of the filters placed downstream of the combustion.

According to some embodiments, non-exhaust gas is introduced via one or more of the inlets as a result of an under-pressure affected by (or caused by) the vent, which creates an airflow of the exhaust gases and non-exhaust gases. In other embodiments, an additional vent can be used to force non-exhaust gas through one or more of the inlets.

According to some embodiments, the operation of one or more vents is determined (or set) to achieve the required properties of gases introduced to the ignition device and/or one or more of the filters. For example, the rate of operation of the vent can be increased to lower the temperature of burned gasses being introduced to a filter and/or to reduce the rate of burnable gases in the exhaust gas introduced to the ignition device.

As used herein, the term “non-exhaust gas” refers to a gas, such as fresh air or non-contaminated air, that is not yet mixed with exhausted materials from the battery under test.

According to some embodiments, the at least one ignition device includes a first ignition device mounted (or arranged) adjacent to the battery test platform. According to some embodiments, the device or system includes one or more additional ignition devices, such as a second and third ignition device. According to some embodiments, one or more of the additional ignition devices is mounted adjacent to the first ignition device, thereby aiding in the combustion process at the same vicinity or at the same burning zone as the first ignition device.

According to some embodiments, one or more of the additional ignition devices is separated from the first ignition device and is arranged downstream thereto to affect ignition to flammable gasses (e.g., to combust flammable gases) that were not ignited by the first ignition device. For example, an additional ignition device may be arranged downstream of a filter while the first ignition device is placed upstream of the filter.

According to some embodiments, the system or the device includes a hood structure affixed to a top portion of the test chamber, such that the filter and the vent are attached to the hood structure. The hood structure can form (or act as) a cover to the test chamber, where burned or unburned exhaust gasses are guided prior to being optionally further treated and then released from the test chamber.

The hood structure can facilitate fitting devices or systems according to the present disclosure in existing test facilities.

According to some embodiments, at least one ignition device is mounted to the hood structure. According to some embodiments, the ignition device mounted to the hood structure is configured to ignite gasses that have already, at least partially, combusted by a first ignition device, thereby affecting the combustion of unburned gasses and mitigating the release of flammable gases from the test chamber.

According to some embodiments, the system or device includes an outlet pipe for guiding burned and/or filtered exhaust gases out of the test chamber. According to some embodiments, the outlet pipe includes a safety flap mounted on a top portion thereof.

The safety flap operates to assure that gases are not trapped in the test chamber, especially when the vent is faulty or is not operated. When the vent is operated, the generated airflow forces the flap to a closed position against a safety outlet in the outlet conduit, thereby directing the air stream through a filter, then via the outlet conduit, to an exhaust outlet in the hood structure. When the vent is not operated, the safety flap is released to an open position away from the safety outlet in the outlet conduit, thereby permitting a flow of exhaust gases through the safety outlet via the outlet conduit and through the exhaust outlet in the hood structure, bypassing a filter.

According to some embodiments, the test chamber includes an air inlet configured to provide air from outside the test chamber into the test chamber. Because the vent(s) generate a flow of gas to be exhausted outside the chamber, the air inlet permits clean, uncontaminated gas to enter the test chamber.

According to some embodiments, at least one (side-)wall of the test chamber is (or includes) a grid wall permeable to the passage of gas therethrough. The grid wall further includes a fire-resistant screen covering at least part of the grid wall from an outer side thereof. In case of an outburst or explosion in the test chamber, the grid wall allows the release of pressure from the test chamber, while the fire-resistant screen mitigates the risk of fire propagation outside the test chamber and reduces the risk of fragments/debris being ejected out of the chamber due to the explosion.

According to some embodiments, the device or system further includes control electronics configured to control the operation of the ignition devices and vents. Furthermore, in some embodiments, the control electronics are connected to at least one sensor within the test chamber or the device. The at least one sensor is configured to provide a signal indicative of: one or more of a temperature in one or more locations or of one or more components in the device or in the system (e.g., the sensor may measure the temperature of gasses in the chamber, the temperature of gasses in the large-particle filter, the temperature of exhaust gases, the temperature of the battery under test, the temperature of gasses after the ignition device, or the like); presence of flammable gases in one or more locations, such as, in the vicinity of the battery under test, in a general location within the chamber, in exhaust gases being released from the test chamber, or the like; and/or air pressure in the chamber, in one or more of the filters, in the outlet conduit, or the like.

According to some embodiments, the control electronics are configured to control the operation of one or more of the vents and/or the ignition devices based on signals received from the at least one sensor.

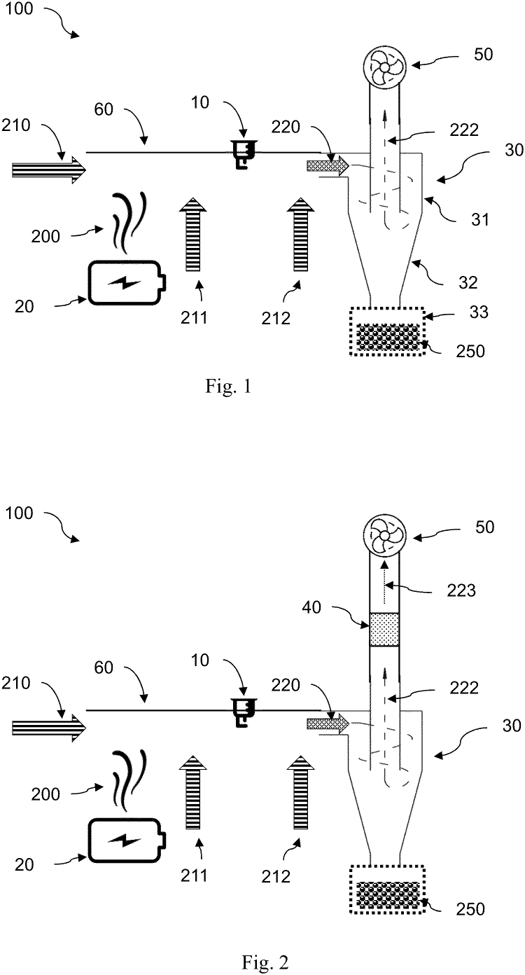

Reference is now made to FIG. 1, which illustrates a schematic functional diagram of a gas treatment device 100 including an ignition device 10 and a cyclone filter 30, according to an embodiment. The gas treatment device 100 is operable during a test procedure of a device under test, such as a battery 20. During the test procedures, for example, during a thermal robustness test, certain reactions may occur in the battery 20 causing it to produce exhaust gases 200. One such reaction is called thermal runaway, which occurs when a cell, or an area within a cell, of the battery 20 reaches high temperatures due to a mechanical failure, a thermal failure, an electric short, a chemical reaction, or an electrochemical reaction.

A vent 50 in the device 100 operates to generate a gas flow, which directs the exhaust gases 200 to (or toward) the ignition device 10. The ignition device 10 affects the combustion of the exhaust gasses 200 to burn them and generate burned exhaust gasses 220, which are then directed through the cyclone filter 30 for separating large particle contaminants from the burned exhaust gasses 220 to release filtered exhaust gases 222.

The cyclone filter 30 pulls in the burned exhaust gasses 220 to a cyclone body 31, in which the gas is forced into a vortex movement and through a conical section 32 of the cyclone filter 30. In the conical section 32, large particles are separated from the gas and fall due t\o gravitational forces to a contaminants container 33 in which the contaminants 250 are collected.

The device 100 further includes gas guide 60 structures, which form a barrier and restricts the flow of gases in certain directions, for example, creating a flow direction from the battery 20 to the ignition device 10 and into the cyclone filter 30. The gas guide 60 further facilitates introducing clean air 210, 211, 212 to be mixed with the exhaust gases at different locations along the flow path of the gas. For example, the gas guide 60 facilitates introducing a first stream of clean air 210 and a second stream of clean air 211 to be mixed with the exhaust gases 200 prior to its introduction to the ignition device 10.

Such a mixture between clean air 210, 211 and exhaust gases 200 results in a mixture that would be ignited efficiently, such that a significant portion or all of the flammable gases in the exhaust gases 200 are burned (or ignited).

The burned exhaust gases 220 can reach high temperatures that could damage the cyclone filter 30 or other components in the device 100. To mitigate this risk, a third stream of clean air 212 is introduced to be mixed with the burned exhaust gases 220 to reduce the temperature thereof.

The device 100, according to some embodiments, further includes at least one more ignition device 10.

Reference is now made to FIG. 2, which illustrates a schematic functional diagram of a gas treatment device 100 including an ignition device 10 and a cyclone filter 30 corresponding to the device 100 shown in FIG. 1 and further including a fine-particle filter 40 according to another embodiment.

The fine-particle filter 40 is placed downstream of the cyclone filter 30 and is configured to receive coarse-filtered gases 222, to further filter them from fine particles, and to provide fine-filtered gases 223 to be released.

As illustrated, the fine-particle filter 40 is located along the path of the airflow between the cyclone filter 30 and the vent 50. However, in other embodiments, the fine-particle filter 40 can be placed after, or downstream to, the vent 50.

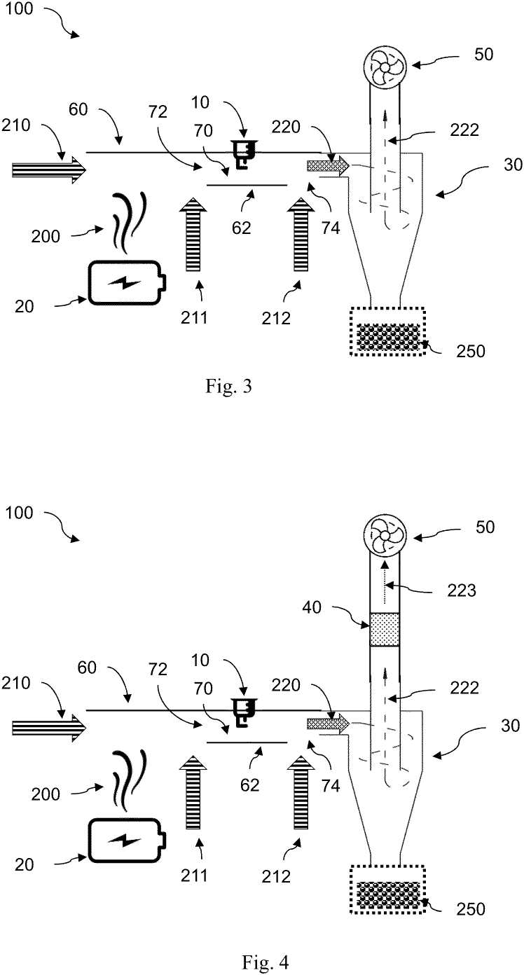

Reference is now made to FIG. 3, which illustrates a schematic functional diagram of a gas treatment device 100 including an ignition device 10 and a cyclone filter 30 corresponding to the device 100 shown in FIG. 1 and further including a combustion barrier 62 according to another embodiment.

The combustion barrier 62 is placed opposite to a portion of the gas guide 60 or may be formed as an integrated part with the gas guide 60 and is configured to physically define a burning zone 70, in which combustion of exhaust gases 200 is performed by the ignition device 10.

The burning zone 70 limits the impact of the combustion on other components of the device 100 and further defines the flow path of exhaust gases 200.

The combustion barrier 62 defines a first gas inlet 72, in which the exhaust gases 200, the first stream of clean air 210, and the second stream of clean air 211 are mixed and introduced to the burning zone 70. The combustion barrier 62 further defines a second gas inlet 74, through which, a third stream of clean air 212 is provided and mixed with the burned exhaust gases 220 before entering the cyclone filter 30.

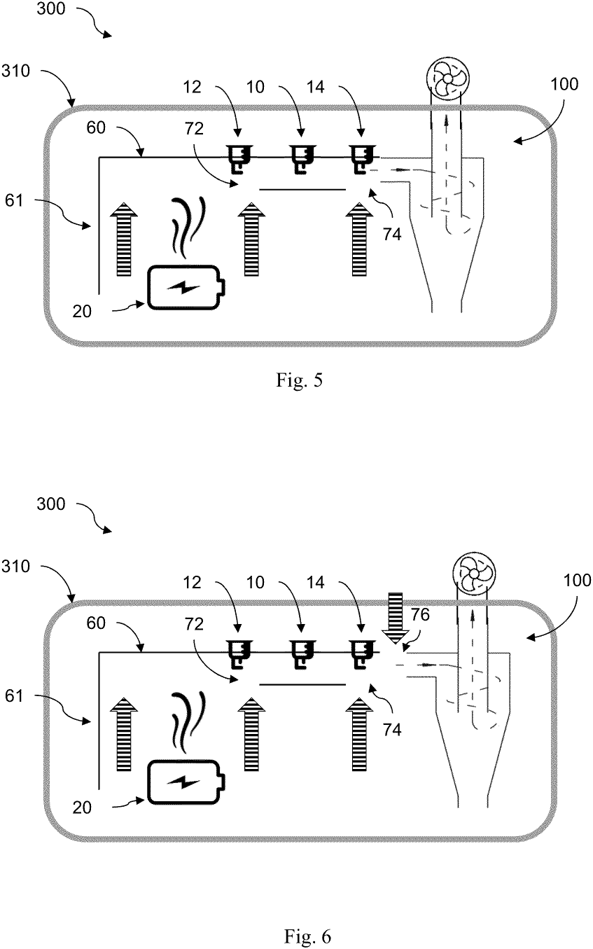

Reference is now made to FIG. 4, which illustrates a schematic functional diagram of a gas treatment device 100 including an ignition device 10, a cyclone filter 30, a fine particle filter 40, and a combustion barrier 62 according to another embodiment.

The device 100 shown in FIG. 4 corresponds to the device 100 shown in FIG. 3 and further includes a fine-particle filter 40 as a secondary filter after the cyclone filter 30.

Reference is now made to FIG. 5, which illustrates a schematic functional diagram of a battery test setting 300 with a gas treatment device 100 placed on a test platform 310 according to another embodiment.

The gas treatment device 100 corresponds to any of the devices 100 shown in FIGS. 1 to 4 and further includes a second ignition device 12 and a third ignition device 14 placed in the vicinity of the ignition device 10 configured to affect efficient combustion of the burned gases in the exhaust gases 200.

According to some embodiments, the ignition devices 10, 12, 14 are arranged along the flow of gas, such as gas which flows in the path affected by the vent 50 is introduced to the ignition devices 10, 12, 14, in serial. In other embodiments, the relative placement of the ignition devices 10, 12, 14 is perpendicular to the flow of gas.

The device 100 shown in FIG. 5 further includes an extension 61 of the gas guide 60 configured to further define the flow of gas affected by the operation of the vent 50 and to limit the escape of exhaust gases 200 from the device 100.

The battery 20 is placed on the test platform 310 for performing a test procedure, such that the gas guide 60 and extension 61 confine a surrounding area of the battery 20, at least from one side thereof.

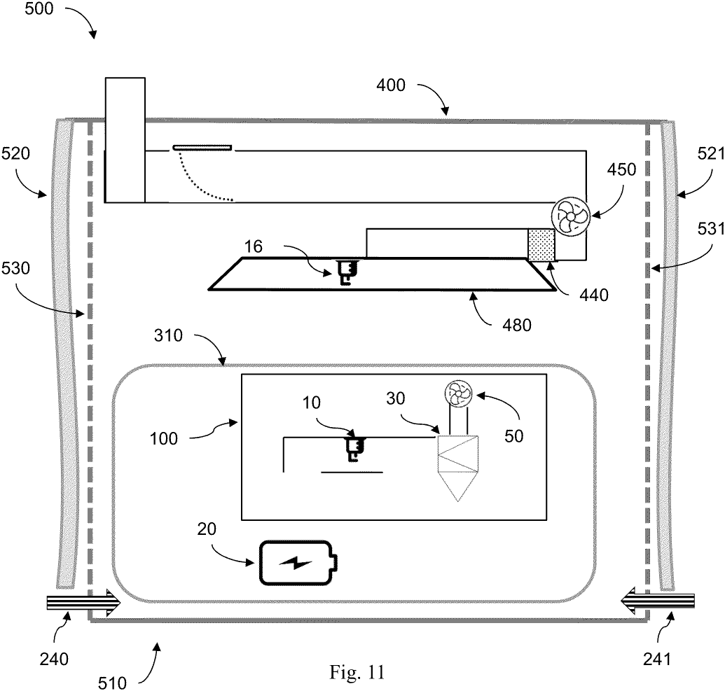

According to some embodiments, the test platform 310 is raised above the floor of the test chamber 510 (see, e.g., FIG. 11), thereby facilitating convenient access to operate the test equipment. In other embodiments, the test platform 310 is placed on the floor of the test chamber 510, thereby facilitating test procedures for large batteries.

Reference is now made to FIG. 6, which illustrates a schematic functional diagram of a battery test setting 300 with a gas treatment device 100 placed on a test platform 310 corresponding to the test platform 310 shown in FIG. 5 in which the cyclone filter 30 is spaced apart from the ignition device(s) 10, 12, 14 according to an embodiment.

The test platform 310 shown in FIG. 6 allows for placing the cyclone filter 30 and the ignition device 10, 12, 14 with space in between to allow for further openings, such as an inlet 76 to introduce greater volumes of clean air 210, 211, 212 before the burned exhaust gases 220 are forced into the cyclone filter 30.

According to some embodiments, the system includes a hood structure 400 configured to cover a top portion of a test chamber 510.

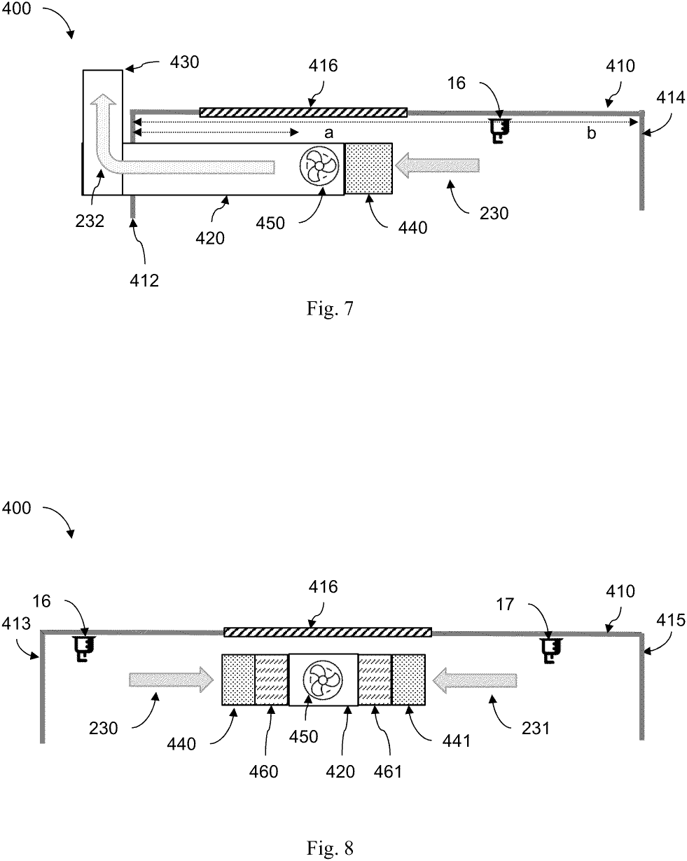

Reference is now made to FIG. 7, which illustrates a schematic functional diagram of a hood structure 400 according to an embodiment.

The hood structure 400 includes a hood cover 410 and side panels 412, 414 with dimensions corresponding to a test chamber 510 on which the hood structure 400 is to be mounted.

The hood structure 400 includes an outlet conduit 420 and a vent 450 configured to force burnt exhaust gases 230 through a fine-particle filter 440 then, via the outlet conduit 420, through a gas outlet 430 to be released.

The hood structure 400 further includes an ignition device 16, which is located upstream of the fine-particle filter 440 and is configured to affect combustion to exhaust gases prior to reaching the fine-particle filter 440.

According to some embodiments, the hood structure 400 is operable in combination with a test device 100 or a test platform 310 such that the ignition device 16 is a secondary ignition device which would affect a combustion to flammable gases that were not combusted in the device 100.

The hood cover 410 further includes a service door 416 for allowing access to the various components of the hood structure 400 during maintenance operations.

According to some embodiments, the hood structure 400 has a length ‘b’ of about 2400 mm and a similar width. According to some embodiments, a distance ‘a’ between the vent 450 and a side panel 412 is about 410 mm.

Reference is now made to FIG. 8, which illustrates a schematic cross-section of a hood structure 400 corresponding to the hood structure 400 shown in FIG. 7 according to an embodiment.

The hood structure 400 includes a hood cover 410 with the service door 416, side panels 413, 415, a first fine-particle filter 440, and a second fine-particle filter 441 arranged at opposite sides of the vent 450 and facilitating passage of burned exhaust gases 230, 231 therethrough. Including more than one fine-particle filter 440, 441 in the system reduces the airflow resistance and allows for greater rates of airflow.

The hood structure 400 further includes filter maintenance covers 460, 461 to allow access to the filters 440, 441 during maintenance operations.

To mitigate the risk of flammable gases escaping the test chamber 510, more than one ignition device are used 16, 17 at different positions in the hood structure 400 corresponding to the flow path of the exhaust gases 230, 231.

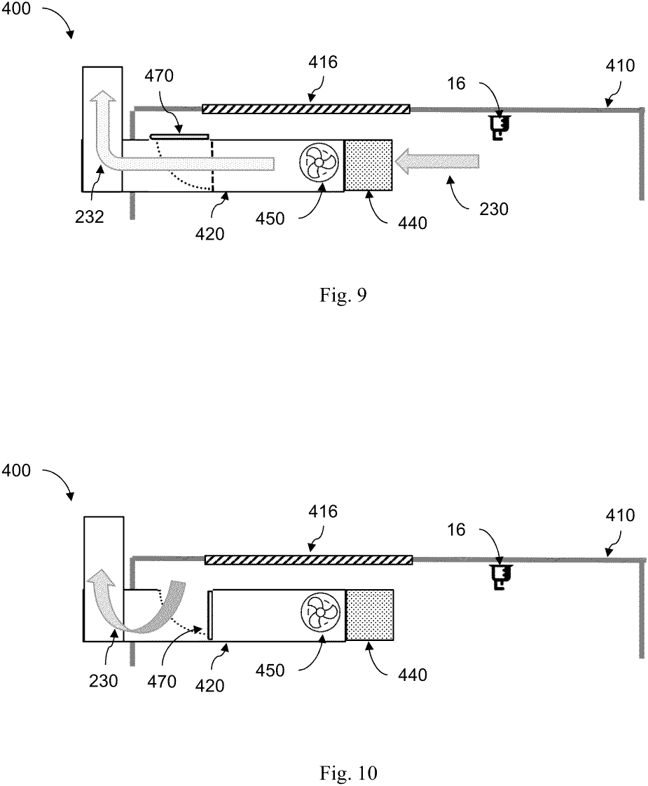

Reference is now made to FIGS. 9 and 10, which illustrate a schematic functional view of a hood structure 400 corresponding to the hood structure 400 shown in FIGS. 7 and 8, with a safety flap 470 according to an embodiment.

The safety flap 470 is installed on the outlet conduit 420 and is configured to facilitate the release of exhaust gases from the test chamber 510 when the vent 450 is not operated or malfunctions.

As illustrated in FIG. 9, under a normal operation of the vent 450, the stream of exhaust gases 232 pushes against the safety flap 470 to raise it to close a safety opening in the outlet conduit 420, thereby allowing for the exhaust gases 232 that have passed through the fine-particle filter 440 to be released normally.

As illustrated in FIG. 10, when the vent 450 is not operating properly or is malfunctioning, a risk of exhaust gas accumulation in the test chamber 510 might occur. In such a case, because the vent 450 is not generating a stream of gas to push against the safety flap 470, the safety flap 470 is released by gravitational force to open a safety opening in the outlet conduit 420 and to allow for exhaust gases 230 to be released without passing through the fine-particle filter 440.

Reference is now made to FIG. 11, which illustrates a schematic view of a battery testing system 500 according to an embodiment.

The battery testing system 500 includes a test chamber 510 in which test procedures for batteries 20 can take place.

The battery testing system 500 includes a test platform 310 corresponding to the test platform 310 shown in FIGS. 5 and 6 located in the test chamber 510 with a gas treatment device 100 corresponding to any of those shown in FIGS. 1 to 4 for performing a test procedure on a battery 20.

Furthermore, the battery testing system 500 includes a hood structure 400 corresponding to any of those shown in FIGS. 7 to 10 and a gas collector 480 for collecting exhaust gases and guiding them through the fine-particle filter 440 to be released. The ignition device 16 is mounted on the gas collector 480 for affecting combustion to flammable gases prior to reaching the fine-particle filter 440.

A first wall 530 and a second wall 531 of the test chamber 510 are grid walls and are covered from the outer side thereof with a first screen 520 and a second screen 521, respectively. The screens 520, 521 are fire-resistant and hang from the top of the walls 530, 531.

The screens 520, 521 are shorter than the walls 530, 531 such that bottom portions of the walls 530, 531 are not covered and provide chamber air inlets 240, 241 to introduce clean air 210, 211, 212 to the test chamber 510.

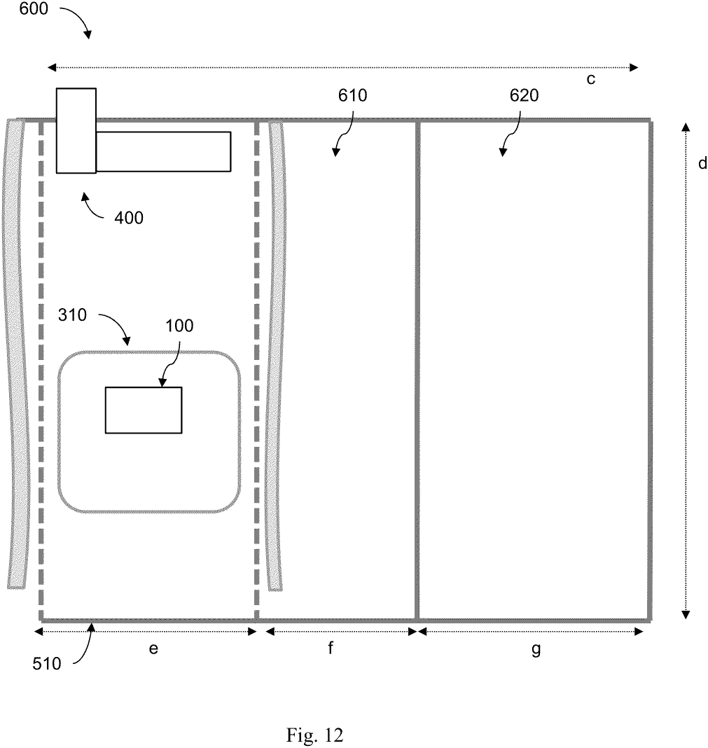

Reference is now made to FIG. 12, which illustrates a schematic view of a battery testing facility 600 according to an embodiment.

The test facility 600 has, in one embodiment, the dimensions of a 20 feet container, which includes a test chamber 510 corresponding to the test chamber 510 shown in FIG. 11 to perform test procedures on batteries.

The testing facility 600 further includes a control/operation room 620, in which an operator can monitor and/or control the battery test procedure, and a safety room 610 between the test chamber 510 and the control room 620 to distance the control room 620 from the test chamber 510 and form a buffer to mitigate the risk for damage to the control room 620.

The height ‘d’ of the testing facility 600 is approximately 2960 mm, the length ‘c’ of the test facility is approximately 6055 mm, and the depth of the testing facility 600 is approximately 2435 mm.

The length ‘e’ of the test chamber 510 is approximately 2.5 m, the length ‘f’ of the safety room 610 is approximately 1.5 m, and the length ‘g’ of the control room 620 is approximately 2 m.

The above dimensions of the testing facility 600 facilitate standard shipping, as they correspond to the dimensions of a standard 20 feet container.

Some Reference Signs

| | |
|---|---|
| 10, 12, 14, 16, 17 | ignition device |
| 20 | battery (or device under test) |
| 30 | cyclone filter |
| 31 | cyclone body |
| 32 | conical section |
| 33 | contaminants container |
| 40, 440, 441 | fine-particle filter |
| 50, 450 | vent |
| 60 | gas guide |
| 61 | extension |
| 62 | combustion barrier |
| 70 | combustion area, burning zone |
| 72, 74, 76 | gas inlet |
| 100 | exhaust gas treatment device |
| 200 | exhaust gasses |
| 210, 211, 212 | clean air |
| 220, 230, 231 | burned exhaust gasses |
| 222, 223, 232 | filtered gasses |
| 240, 241 | chamber air inlet |
| 250 | collected contaminants/particles |
| 300 | battery test setting |
| 310 | test platform |
| 400 | hood structure |
| 410 | hood cover |
| 412, 413, 414, 415 | side panel |
| 416 | service door |
| 420 | outlet conduit |
| 430 | gas outlet |
| 470 | safety flap |
| 480 | gas collector |
| 500 | battery testing system |
| 510 | test chamber |
| 520, 521 | screen |
| 530, 531 | wall of the test chamber |
| 600 | testing facility |
| 610 | safety room |
| 620 | control room |

What is claimed is:

1. A battery testing system comprising:
a test chamber;
a battery test platform within the test chamber, the battery test platform being configured to accommodate a battery and to performing a test to the battery; and
an ignition device configured to combust exhaust gases produced in the test chamber during the battery test while the exhaust gasses are in the battery testing system.

2. The battery testing system of claim 1, further comprising:
a filter configured to remove contaminants from exhaust gasses passing therethrough; and
a vent configured to direct exhaust gasses through the filter and to direct an air stream in which a downstream direction is a direction in which air is guided through the filter,
wherein the filter is downstream of the ignition device such that the ignition device is configured to combust the exhaust gases prior to the exhaust gases being directed through the filter.

3. The battery testing system of claim 2, wherein the filter comprises a cyclone filter adjacent to and downstream of the ignition device.

4. The battery testing system of claim 3, further comprising a fine-particle filter downstream of the cyclone filter and configured to filter contaminants from exhaust gasses which have passed through the cyclone filter.

5. The battery testing system of claim 2, further comprising a first gas inlet configured to introduce non-exhaust gases to the exhaust gases prior combustion.

6. The battery testing system of claim 5, further comprising a second gas inlet between the ignition device and the filter and configured to introduce non-exhaust gases to exhaust gases after the combustion thereof and prior to the combusted exhaust gases being directed through the filter.

7. The battery testing system of claim 2, wherein the ignition device comprises a first ignition device adjacent to the battery test platform.

8. The battery testing system of claim 7, further comprising a hood structure affixed to a top portion of the test chamber such that the filter and the vent are attached to the hood structure.

9. The battery testing system of claim 8, wherein the ignition device further comprises a second ignition device mounted on the hood structure.

10. The battery testing system of claim 8, wherein the hood structure comprises a safety flap mounted on a top portion of the hood structure such that:
when the vent is operated, the generated air stream forces the safety flap to a closed position against a safety outlet in the hood structure thereby directing the air stream to a gas outlet in the hood structure; and
when the vent is not operated, the safety flap is released to an open position away from the safety outlet in the hood structure thereby permitting a flow of exhaust gases through the safety outlet in the hood structure,
wherein the test chamber comprises an air inlet configured to provide air from outside the test chamber into the test chamber.

11. The battery testing system of claim 1, further comprising a fire-resistant screen,
wherein a wall of the test chamber comprises a grid wall, and the fire-resistant screen covers at least part of the grid wall at an outer side thereof.

12. An exhaust gas treatment device operable in a test chamber for battery testing, the exhaust gas treatment device comprising:
an ignition device configured to combust exhaust gases produced in the test chamber during a battery test while the exhaust gasses are in the test chamber.

13. The exhaust gas treatment device of claim 12, further comprising:
a filter configured to remove contaminants from gasses passing therethrough; and
a vent configured to direct the exhaust gasses through the filter and to form a directed air stream in which a downstream direction is a direction in which air is guided through the filter,
wherein the filter is downstream of the ignition device such that the ignition device is configured to combust exhaust gases prior to the exhaust gases being directed through the filter.

14. The exhaust gas treatment device of claim 13, wherein the filter comprises a cyclone filter adjacent to and downstream of the ignition device.

15. The exhaust gas treatment device of claim 14, further comprising a first gas inlet configured to introduce non-exhaust gases to the exhaust gases prior to the combustion.

16. The exhaust gas treatment device of claim 15, further comprising a second gas inlet between the ignition device and the filter and configured to introduce non-exhaust gases to exhaust gases after the combustion thereof and prior to the combusted exhaust gases being directed through the filter.

17. A method for exhaust gas treatment in the battery testing system as claimed in claim 1, the method comprising:
performing a battery test procedure on a battery;
igniting exhaust gases produced during the battery test procedure to combust the exhaust gases;
guiding the combusted gases through a filter; and
filtering pollutants from the guided combusted gases.
